(19) United States
(12) Patent Application Publication
(10) Pub. No.: US 2017/0107420 A1
(43) Pub. Date: Apr. 20, 2017

(54) COMPOSITIONS AND METHODS FOR COMPLETING SUBTERRANEAN WELLS

(71) Applicant: SCHLUMBERGER TECHNOLOGY CORPORATION, Sugar Land, TX (US)

(72) Inventors: Cyril Terrier, Clamart (FR); Isabelle Couillet, Clamart (FR); Hafida Achtal, Clamart (FR)

(21) Appl. No.: 15/127,234

(22) PCT Filed: Mar. 31, 2015
(86) PCT No.: PCT/EP2015/000682

§ 371 Date: Sep. 19, 2016

(30) Foreign Application Priority Data
Mar. 31, 2014 (EP) 14305465.8

(51) Int. Cl. C09K 8/487; C09K 8/473; E21B 33/14; C04B 28/04; C04B 24/22; C04B 24/38; C09K 8/48; C09K 8/46

(52) U.S. Cl. CPC C09K 8/487; C09K 8/48; C09K 8/473; C09K 8/46; C04B 28/04; C04B 24/22; C04B 24/383; E21B 33/14; C04B 2103/408

(57) ABSTRACT

Hydroxyethylcellulose (HEG) may be used to provide fluid-loss control in well-cement slurries HECs that have a molecular weight above 600,000, a degree of substitution higher than 1.9 and a molar substitution above 2.0 are particularly useful in that they not only provide fluid-loss control, but also may be used as a cement extender. Furthermore, the retardation effect may be reduced.

### BACKGROUND

The statements in this section merely provide background information related to the present disclosure and may not constitute prior art.

This disclosure relates to compositions and methods for completing subterranean wells, in particular, fluid compositions and methods for completion operations during which the fluid compositions are pumped into a wellbore and make contact with subterranean rock formations.

In the course of completing oil and gas wells and the like, various types of fluids are circulated in the wellbore. These fluids include, but are not limited to, drilling fluids, spacer fluids, cement slurries and gravel-packing fluids. In addition, these fluids typically contain solid particles. Fluid hydrostatic pressure and pumping pressure create a pressure differential between the wellbore and the surrounding formation rock. As a result, the liquid portion of the fluid has a tendency to enter pores in the subterranean rock, migrate away from the wellbore, and leave the solid particles behind. In other words, a filtration process occurs that is commonly known in the art as “fluid loss.”

Excessive fluid loss may have undesirable consequences. For example, as more and more liquid exits the wellbore and penetrates the subterranean rock, the solids left behind may concentrate and form a plug, preventing further fluid flow in the wellbore and terminating the completion process prematurely. Liquid entering the formation rock may interact with minerals such as clays, causing the rock to lose permeability—a condition known in the art as “formation damage.” The rheological and chemical properties of a completion-fluid system may also be sensitive to the ratio between the liquid and solid ingredients. Disruption of the optimal liquid-solid ratio arising from fluid loss may have a detrimental effect on the completion process and cause failure.

Control of fluid loss is particularly important during primary and remedial well-cementing operations. The goal of primary cementing is to pump a cement slurry in the well and fill the annular space between a casing string and the subterranean rock. The slurry may be pumped down through the casing interior and up the annulus, or vice versa. When the cement slurry hardens, it supports the casing in the well and provides a hydraulic seal between formation strata. Fluid-loss control during primary cementing is necessary to control the rheological properties of the cement slurry, to ensure that chemical reactions in the slurry proceed properly, and to obtain a durable hardened cement that will provide hydraulic isolation throughout the life of the well.

Remedial cementing consists of two main procedures—plug cementing and squeeze cementing. Fluid-loss control is particularly pertinent to squeeze cementing. Squeeze cementing is a process for restoring hydraulic isolation. A cement slurry is pumped downhole to seal casing leaks or voids behind the casing that have allowed hydraulic communication between formation strata. Squeeze cementing involves injecting a cement slurry into strategic locations that are often very small. Fluid-loss control is necessary to avoid premature solids bridging, and to ensure that the cement slurry arrives and hardens at the correct location.

Most well-cementing operations employ aqueous cement systems based on Portland cement. These systems may contain solid extenders such as fly ash, blast-furnace slag, silica, clays and zeolite minerals. Recently, Portland cement manufacturers began offering “composite cements,” wherein materials such as fly ash blast-furnace slag and zeolites are either interground with Portland-cement clinker or blended with finished Portland cement.

Other aqueous compositions that are used less frequently include calcium aluminate cement, Class C fly ash, blends of lime and silica, chemically activated phosphate ceramics, alkali activated blast-furnace slags and geopolymers. The term cement is broadly used herein to include these aqueous well compositions as well as hydraulic and Portland-base systems generally. In addition, drilling fluids are available that, after drilling is completed and casing is lowered into the well, may be chemically activated and converted into a cement.

A fluid-loss additive commonly known in the art is hydroxyethylcellulose (HEC). Most HECs employed in well cementing operations have a degree of substitution (DS) between about 0.25 and 2.5. Various HEC molecular weights have been used, chosen according to the density of the cement slurry in which they are added. For normal-density slurries (e.g. 1800-1920 kg/m³ [15.0-16.0 lbm/gal]), an HEC of medium molecular weight (2% solution viscosity≈40 cP) may be used. A higher molecular weight HEC (2% solution viscosity≈180 cP) may be used in lower density slurries (1320-1680 kg/m³ [11.0-14.0 lbm/gal]).

HEC fluid-loss additives generally share certain disadvantages. They are effective water viscosifiers; as a result, they may increase the difficulty of slurry mixing and ultimately cause undesirable cement-slurry viscosification. At temperatures less than about 65° C. [150° F.], HECs are efficient retarders; thus, care must be taken to avoid slurry overretardation. The retardation tendency may be magnified at lower slurry densities (1320-1680 kg/m³ [11.0-14.0 lbm/gal]). Furthermore, the efficiency of HECs decreases with increasing temperature.

### SUMMARY

The objective of this patent application is to disclose well cement compositions that comprise HECs with reduced retarding effects. In addition, methods are disclosed for applying the compositions.

In an aspect, embodiments relate to compositions comprising water, a hydraulic cement, a cement dispersant and hydroxyethylcellulose, wherein the hydroxyethylcellulose has a molecular weight between 600,000 g/mol and 1,500,000 g/mol, and a molar substitution between 2.0 and 3.5. The viscosity of the composition is lower than 1000 cP at a shear rate of 100 s⁻¹.

In a further aspect, embodiments relate to methods for cementing a subterranean well. A cement slurry is prepared that comprises water, a hydraulic cement, a cement dispersant and hydroxyethylcellulose, wherein the hydroxyethylcellulose has a molecular weight between 600,000 and 1,500,000, and a molar substitution between 2.0 and 3.5. The viscosity of the slurry is lower than 1000 cP at a shear rate of 100 s⁻¹.

### BRIEF DESCRIPTION OF THE DRAWINGS

For a more complete understanding of the present disclosure, and the advantages thereof, reference is now made to the following descriptions taken in conjunction with the accompanying figures.

FIG. 1 presents thickening-time test curves from two cement slurries containing HEC.

FIG. 2 presents calorimetric heat-flow curves generated from cement slurries containing various HECs and well as a control slurry that did not contain HEC.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read: once as modified by the term “about” (unless already expressly so modified), and then read again as not so modified unless otherwise indicated in context. Also, in the summary of the disclosure and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Fluid-loss control is an important performance parameter of well-cement slurries. The present application discloses cement slurries that contain HECs with reduced retardation and viscosification tendencies. These features allow their use not only as fluid-loss additives but also as extenders that contribute to slurry stability.

The. HEC polymers of the present disclosure have a molecular weight between 600,000 and 1,500,000, and a molar substitution (MS) between 2.0 and 3.5. The degree of substitution (DS) may: be between 1.9 and 2.5.

In an aspect, embodiments relate to compositions comprising water, a hydraulic cement, a cement dispersant and HEC, wherein the HEC has a molecular weight between 600,000 and 1,500,000, and a molar substitution between 2.0 and 3.5. The viscosity of the composition is lower than 1000 cP at a shear rate of 100 s⁻¹. Compositions meeting this viscosity limitation are known in the art as being pumpable in the context of well cementing operations.

In a further aspect, embodiments relate to methods for cementing a subterranean well. A cement slurry is prepared that comprises water, a hydraulic cement, a cement dispersant and HEC, wherein the HEC has a molecular weight between 600,000 and 1,500,000, and a molar substitution between 2.0 and 3.5. The viscosity of the slurry is lower than 1000 cP at a shear rate of 100 s⁻¹. The methods may comprise placing the slurry during a primary cementing operation or a remedial cementing operation.

For both aspects, the cement dispersant may be polynaphthalene sulfonate or a polycarboxylate. The dispersant may be present at a concentration between 0.3% and 1.5% by weight of cement.

For both aspects, the HEC may be present at a concentration between 0.4% and 1.5% by weight of cement.

For both aspects, the hydraulic cement may comprise portland cement, calcium aluminate cement, lime/silica blends, fly ashes, blast furnace slags or zeolites or combinations thereof. The hydraulic cement may be portland cement.

For both aspects, the density of the composition or slurry may be between 1320 kg/m³ and 1920 kg/m³ (11.0 and 16.0 lbm/gal), or between 1440 kg/m³ and 1560 kg/m³ (12.0 and 13.0 lbm/gal).

For both aspects, the composition or slurry may further comprise accelerators, retarders, extenders, weighting agents, antifoam agents, fluid-loss control agents, nitrogen or gas-generating agents, or combinations thereof.

### EXAMPLES

The following examples serve to further illustrate the disclosure. Many of the materials listed in the tables describing cement-slurry compositions are common products that are well known in the well-cementing industry.

All of the tests described below were performed in accordance with recommended laboratory practices published by the American Petroleum Institute (Publication RP10B). All tests were performed with Class G cement.

### Example 1

Two different HECs, described in Table 1, were tested. EcoDura™ TA 4283 and SHEC-L are available from Ashland, Inc. The HEC concentrations in the products was 20 wt %.

TABLE 1
Properties of HEC polymers.

| Product | EcoDura ™ TA 4283 | EcoDura ™ SHEC-L |
|---|---|---|
| Molecular Weight | 2,000,000 | 1,300,000 |
| [Da] | | |
| MS | 2.1 | 3.3 |
| DS | <1.9* | >1.9** |
| Carrier fluid | Brine | Brine |
| SG [g/cm³] | 1.26 | 1.32 |

*lower limit = 0.25;
**upper limit = 3.0

This example illustrates the performance of the disclosed HEC additives as cement slurry extenders (Table 2). The density of the four slurries described in Table 2 was 1440 kg/m³ (12.0 lbm/gal).

TABLE 2
Stability and fluid-loss of low-density HEC extended cement slurries.

| | Slurry Reference | | | |
|---|---|---|---|---|
| | 1 | 2 | 3 | 4 |
| Composition | | | | |
| Antifoam† (L/tonne) | 1.0 | 1.0 | 1.0 | 1.0 |
| PNS* (L/tonne) | 11.1 | 11.1 | 11.1 | 2.66 |
| Calcium Chloride | — | 26.7 | 26.7 | — |
| (L/tonne) | | | | |
| EcoDura ™ TA 4283 | — | — | 28.4 | — |
| (L/tonne) | | | | |
| EcoDura ™ SHEC-L | 31.1 | 28.4 | — | 31.1 |
| (L/tonne) | | | | |
| Water | sea water | fresh water | fresh water | fresh |
| | | | | water |
| Performance | | | | |
| Temperature (° C.) | 40 | 40 | 40 | 85 |
| 2-h Free Fluid (%) | 0.0 | 0.2 | 0.0 | 0.0 |
| API Free Fluid | 0.0 | — | — | trace |
| 45° (%) | | | | |
| Sedimentation (%) | 3.7 | 4.0 | — | 0.9 |
| API Fluid Loss (mL) | 89 | 76 | 140 | 810 |

*PNS = polynaphthalene sulfonate
†polypropylene glycol

It is generally accepted in the art that the API fluid loss value should at most 100 mL. In addition, free fluid should be lower than 0.8% (2.0 mL in a 250-mL graduated cylinder), and the sedimentation ratio should be below 5.0%.

Slurries 1, 2 and 3 demonstrate that the use of HECs having a. molecular weight higher then 600,000 g/mol and a MS above 2.0, along with a dispersant, stabilized and provided adequate fluid-loss control in low-density, high-water-content cement slurries.

Slurry. 4 demonstrated that when the dispersant concentration is too low (<0.3% by weight of cement [BWOC]), slurry stabilization was achieved, but adequate fluid-loss control was not provided.

### Example 2

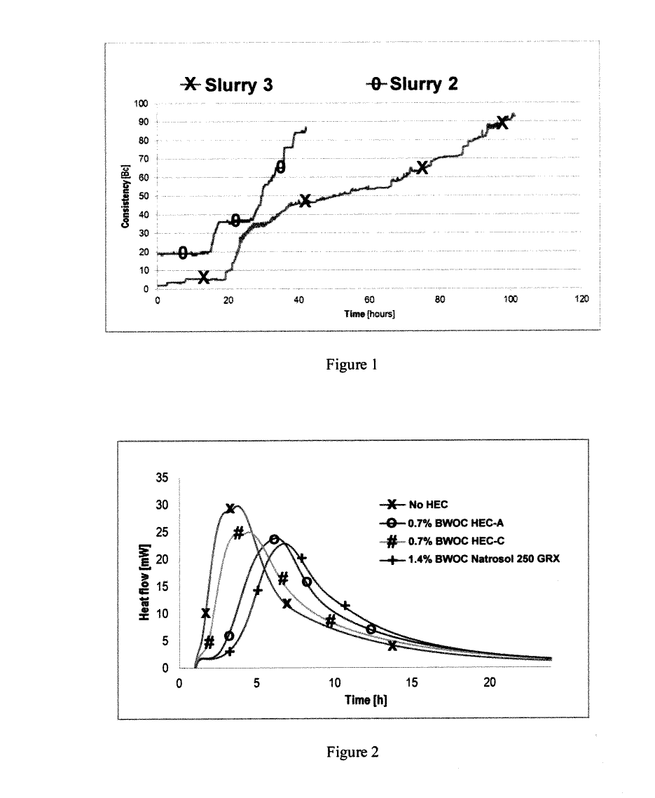

The concepts illustrated in Example 1 were extended to an investigation of the effects of the. HECs on the setting behavior of cement slurries. Thickening time tests were performed with two slurries. Slurry 2 contained EcoDura™ SHEC-L, which has a DS higher than 1.9; Slurry 3 contained EcoDURA™ TA 4283, which has a DS lower than 1.9. The thickening time results are presented in Table 3 and FIG. 1.

TABLE 3
Setting behavior of two slurries containing HEC.

Slurry Reference

| Composition | 2 | 3 |
|---|---|---|
| Antifoam (L/tonne) | 1.0 | 1.0 |
| PNS* (L/tonne) | 11.1 | 11.1 |
| Calcium Chloride | 26.7 | 263 |
| (L/tonne) | | |
| EcoDura ™ TA 4283 | — | 28.4 |
| (L/tonne) | | |
| EcoDura ™ SHEC-L | 28.4 | — |
| (L/tonne) | | |
| Water | fresh water | fresh water |
| Thickening Time | (h:min) | (h:min) |
| Point of Departure | 15:08 | 21:01 |
| 30 Bc | 16:19 | 24:56 |
| 70 Bc | 35:53 | 79:30 |
| 100 Bc | — | — |

The point of departure (POD) is defined as the time at which the slurry viscosity begins to increase with respect to the initial plateau value. EcoDura™ A 4283 has a DS below 1.9 and therefore was a strong retarder (POD=21 h). EcoDura™ SHEC-L has a DS above 1.9 and retarded the slurry to a lesser degree.

### Example 3

Three different HECs, described in Table 4, were tested. Natrosol™ 250, HEC-A and HEC-B are available from Ashland, Inc.

TABLE 4
Properties of HEC polymers.

| Product | HEC-A | HEC-C | Natrosol ™ 250 GRX |
|---|---|---|---|
| Molecular Weight | 1,000,000 | 1,000,000 | 350,000 |
| [Da] | | | |
| MS | 2.5 | 3.2 | 2.5 |
| DS | <1.9* | 2.1 | 1.48 |
| SG [g/cm³] | 1.41 | 1.36 | 1.38 |

*lower limit = 0.25

Four cement slurry designs (Table 5) were prepared containing the HECs described in Table 4. The density of the slurries was 1560 kg/m³ (13.0 lbm/gal), and the tests were performed at 50° C. (122° F.). Sodium metasilicate was present as an extender.

TABLE 5
Compositions and performance of four cement systems with
and without HEC.

| | Slurry Reference | | | |
|---|---|---|---|---|
| | 5 | 6 | 7 | 8 |
| Composition | | | | |
| Antifoam (% BWOC) | 0.07 | 0.07 | 0.07 | 0.07 |
| PNS (% BWOC) | 0.5 | 0.5 | 0.5 | — |
| Sodium Metasilicate | 0.8 | 0.8 | 0.8 | 0.8 |
| (% BWOC) | | | | |
| Natrosol ™ 250 GRX | 1.4 | — | — | — |
| (% BWOC) | | | | |
| HEC-A (% BWOC) | — | 0.7 | — | — |
| HEC-C (% BWOC) | — | — | 0.7 | — |
| Water | fresh | fresh water | fresh water | fresh water |
| | water | | | |
| Performance | | | | |
| 2-h Free Fluid (%) | 0.0 | 0.0 | 0.0 | — |
| API Fluid Loss (mL) | 90 | 100 | 100 | — |

Slurries 5-7 contained HEC and Slurry 8 was a control system. The performance of the HEC-containing slurries was acceptable in terms of free fluid and API fluid loss.

The hydration kinetics of the four cement systems was determined by measuring heat flow in an atmospheric, non-ppressurized calorimeter. The results, presented in FIG. 2, showed that HEC-C (DS>1.9) had a smaller retarding effect than HEC-A and Natrosol™ 250 GRX, whose DSs were lower than 1.9.

Although various embodiments have been described with respect to enabling disclosures, it is to be understood the disclosure is not limited to the disclosed embodiments. Variations and modifications that would occur to one of skill in the art upon reading the specification are also within the scope of the disclosure, which is defined in the appended claims.

1. A well cementing composition, comprising:
(i) water;
(ii) a hydraulic cement;
(iii) a cement dispersant; and
(iv) hydroxyethylcellulose, wherein the hydroxyethylcellulose has a molecular weight between 600,000 g/mol and 1,500,000 g/mol and a molar substitution between 2.0 and 3.5 wherein the composition has a viscosity lower than 1000 cP at a shear rate of 100 s⁻¹.

2. The composition of claim 1, wherein the hydroxyethylcellulose has a degree of substitution between 1.9 and 2.5.

3. The composition of claim 1, wherein the cement dispersant is polynaphthalene sulfonate, present at a concentration between 0.3% and 1.5% by weight of cement.

4. The composition of claim 1, wherein the cement dispersant is a polycarboxylate, present at a concentration between 0.3% and 1.5% by weight of cement.

5. The composition of claim 1, wherein the hydroxyethylcellulose is present at a concentration between 0.4% and 1.5% by weight of cement.

6. The composition of claim 1, wherein the hydraulic cement is portland cement.

7. The composition of claim 1, wherein the composition further comprises an accelerator, a retarder, an extender, a weighting agent, an antifoam agent, nitrogen, a fluid-loss control agent or a gas generating agent, or a combination thereof.

8. A method for cementing a subterranean well, comprising:
(i) preparing a cement slurry comprising water, a hydraulic cement, a cement dispersant and hydroxyethylcellulose, wherein the hydroxyethylcellulose has a molecular weight between 600,000 g/mol and 1,500,000 g/mol and a molar substitution between 2.0 and 3.5; and
(ii) placing the slurry into the well;
wherein the slurry has a viscosity lower than 1000 cP at a shear rate of 100 s⁻¹.

9. The method of claim 8, wherein the hydroxyethylcellulose has a degree of substitution between 1.9 and 2.5.

10. The method of claim 8, wherein the cement dispersant is polynaphthalene sulfonate or a polycarboxylate, present at a concentration between 0.3% and 1.5% by weight of cement.

11. The method of claim 8, wherein the hydroxyethylcellulose is present at a concentration between 0.4% and 1.5% by weight of cement.

12. The method of claim 8, wherein the hydraulic cement is portland cement.

13. The method of claim 8, wherein the composition further comprises an accelerator, a retarder, an extender, a weighting agent, an antifoam agent, nitrogen, a fluid-loss control agent or a gas generating agent, or a combination thereof.

14. The method of claim 8, wherein the cement slurry is placed during a primary cementing operation.

15. The method claim 8, wherein the cement slurry is placed during a remedial cementing operation.
